(19) United States
(12) Patent Application Publication
(10) Pub. No.: US 2026/0044990 A1
(43) Pub. Date: Feb. 12, 2026

(54) NEURAL NETWORK FEATURE MAP TRANSLATION FOR VIDEO CODING

(71) Applicant: MEDIATEK INC., Hsinchu City (TW)

(72) Inventors: Wen-Chun LIN, Hsinchu City (TW); Chih-Yao CHIU, Hsinchu City (TW); Guan-Hao CHEN, Hsinchu City (TW); Ching-Yeh CHEN, Hsinchu City (TW); Tzu-Der CHUANG, Hsinchu City (TW); Yu-Wen HUANG, Hsinchu City (TW); Jan KLOPP, Hsinchu City (TW)

(21) Appl. No.: 18/998,325

(22) PCT Filed: Aug. 14, 2023
(86) PCT No.: PCT/CN2023/112852

§ 371 Date: Jan. 24, 2025

Related U.S. Application Data
(60) Provisional application No. 63/373,208, filed on Aug. 23, 2022.
(60) Provisional application No. 63/497,760, filed on Apr. 24, 2023.

(51) Int. Cl. G06T 9/00; H04N 19/82

(52) U.S. Cl. CPC G06T 9/002; H04N 19/82

(57) ABSTRACT

A video coding method that uses a neural network to perform in-loop filtering is provided. The video coder provides a neural network filter by spatially shifting a feature map of the neural network. The video coder reconstructs a current block of pixels of a current picture of a video based on prediction residuals generated or received by the video coder. The video coder filters samples of the reconstructed current block by using the neural network filter. The video coder encodes or decodes a subsequent block of the video by inter- or intra-prediction based on the filtered samples of the current block.

### CROSS REFERENCE TO RELATED PATENT APPLICATION(S)

The present disclosure is part of a non-provisional application that claims the priority benefit of U.S. Provisional Patent Application Nos. 63/373,208 and 63/497,760, filed on 23 Aug. 2022 and 24 Apr. 2023, respectively. Contents of above-listed applications are herein incorporated by reference.

### TECHNICAL FIELD

The present disclosure relates generally to video coding. In particular, the present disclosure relates to methods of decoding video pictures using neural network feature map translation.

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs).

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). The leaf nodes of a coding tree correspond to the coding units (CUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types: quad-tree partitioning, vertical binary tree partitioning, horizontal binary tree partitioning, vertical center-side triple-tree partitioning, horizontal center-side triple-tree partitioning.

Each CU contains one or more prediction units (PUs). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and two corresponding transform blocks of chroma samples and each TB correspond to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one-color component associated with CTU, CU, PU, and TU, respectively. Thus, a CTU consists of one luma CTB, two chroma CTBs, and associated syntax elements. A similar relationship is valid for CU, PU, and TU.

For each inter-predicted CU, motion parameters consisting of motion vectors, reference picture indices and reference picture list usage index, and additional information are used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU. The alternative to merge mode is the explicit transmission of motion parameters, where motion vector, corresponding reference picture index for each reference picture list and reference picture list usage flag and other needed information are signalled explicitly per each CU.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide a video coding method that uses a neural network to perform in-loop filtering. The neural network has a plurality of layers, each layer supporting one or more feature maps. In some embodiments, the neural network filter is trained by data that is generated outside of a video coding loop. The video coder provides the neural network filter by spatially shifting a feature map of the neural network. The video coder reconstructs a current block of pixels of a current picture of a video based on prediction residuals generated or received by the video coder. The video coder filters samples of the reconstructed current block by using the neural network filter. The video coder encodes or decodes a subsequent block of the video by inter- or intra-prediction based on the filtered samples of the current block.

In some embodiments, the encoder provides the neural network by identifying one or more layers having feature maps to be shifted. The encoder may identify a set of different translation offsets to be applied to feature maps of the identified layer, with each translation offset specifying a pattern of movement for shifting a feature map. In some embodiments, each translation offset in the set of translation offsets is applicable to a group of one or more feature maps of the identified layer. In some embodiments, the encoder signals a specification of translation offsets of feature maps for only a subset of the plurality of layers and not all layers of the neural network.

In some embodiments, the encoder shifts the feature map by filling vacated elements of the feature map with padding samples. In some embodiments, the encoder shifts the feature map by shifting an output of the feature map in a first layer of the neural network according to an offset and applying the shifted output as input to a second layer of the neural network. In some embodiments, the encoder shifts the feature map by applying an offset to a read pointer that is used to retrieve data of the feature map from a storage. In some embodiments, the encoder shifts the feature map by applying an offset to a write pointer that is used to store data of the feature map to a storage.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 conceptually illustrates a video decoding system in which a neural network is used as a post-loop filter.

FIGS. 2A-B show video encoding and decoding systems having neural network in-loop filters.

FIG. 3 conceptually illustrates shifting a feature map in horizontal or vertical direction by certain offsets.

FIGS. 4A-C conceptually illustrates implementations of feature map shifting in different embodiments.

FIG. 5 conceptually illustrates a neural network layer having multiple different feature maps being shifted by different offsets in either direction.

FIG. 6 illustrates an example video encoder that may implement an in-loop neural network filter.

FIG. 7 illustrates portions of the video encoder that implement an in-loop neural network filter.

FIG. 8 conceptually illustrates a process for encoding video pictures using an in-loop neural network filter.

FIG. 9 illustrates an example video decoder that may implement an in-loop neural network filter.

FIG. 10 illustrates portions of the video decoder that implement an in-loop neural network filter.

FIG. 11 conceptually illustrates a process for decoding video pictures using an in-loop neural network filter.

FIG. 12 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. In-Loop Neural Network Filter

A video coding system may incorporate a small neural network (NN) to achieve coding gain as an image restoration method, and the NN may do so with only hundreds of operations per pixel. The NN can be trained on a limited set of up to several hundred frames, and the trained NN may be signaled to the decoder. The signaling occurs either using quantized or original floating-point parameters.

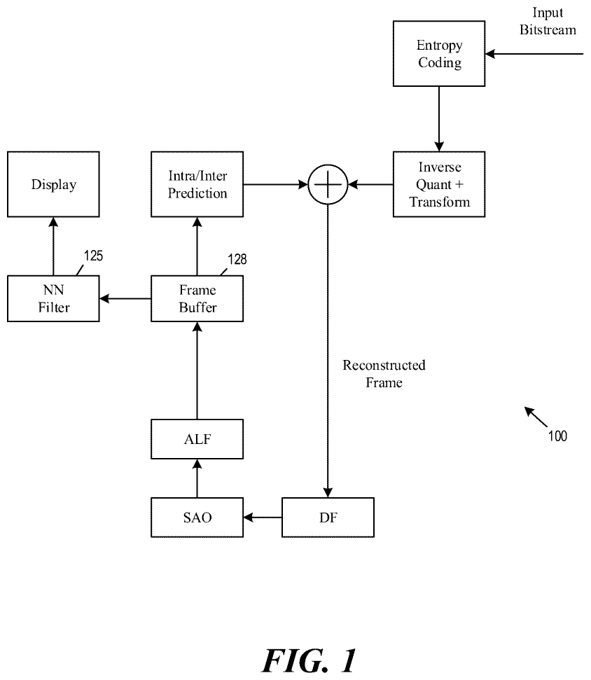

The NN may be applied as a post-loop filter after the decoding loop, i.e., the outputs of the NN are not used as reference for another frame. FIG. 1 conceptually illustrates a video decoding system 100 in which a neural network 125 is used as a post-loop filter. As illustrated, decoded/reconstructed frames stored in a frame buffer 128 are provided to the neural network 125 to perform NN-based filtering prior to display. The result of the NN-based filtering is not stored back to the frame buffer 128 and not used for subsequent inter and/or intra prediction.

As a post-loop filter, the impact and coding gain of the NN on noise reduction is limited because the processed content is not reused. If a post-loop training process were to be applied to an in-loop encoding or decoding process, a mismatch may occur since the NN trained on after-loop data will have to process in-loop data created by referencing the NN's own output through e.g., motion compensation or intra-prediction.

Some embodiments of the disclosure provide an in-loop convolutional neural network (CNN) as an image restoration method in a video coding system. The method can be applied to the output of the adaptive loop filter (ALF) to generate the final restored picture, the samples of which can be used for inter- or intra-prediction of subsequent pictures or blocks. This method can also be directly applied after sample adaptive offset (SAO), deblock filter (DF), or reconstruction (REC), with or without other restoration methods in one video coding system.

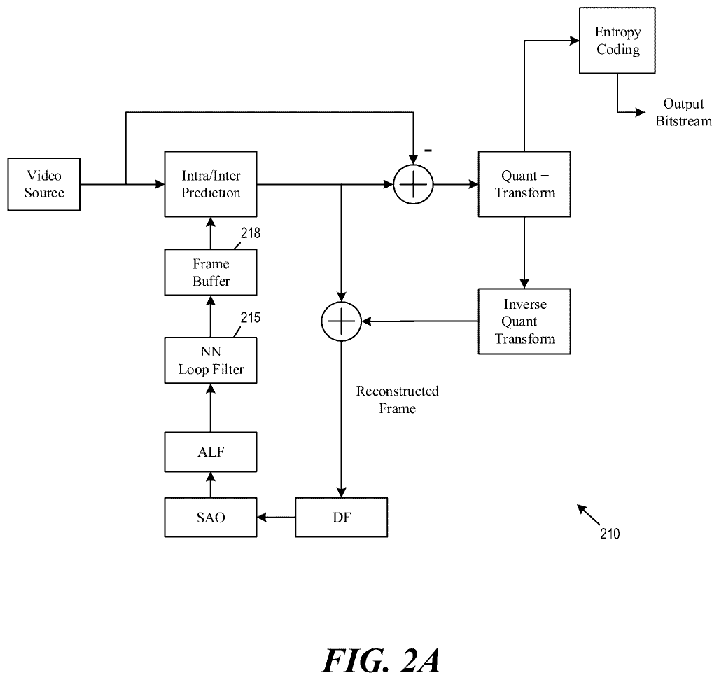

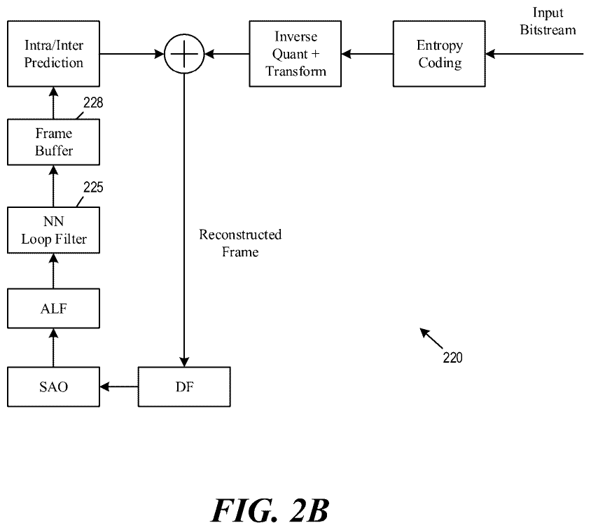

FIG. 2A shows a video encoding system 210 having a neural network in-loop filter 215. FIG. 2B shows a video decoding system 220 having a neural network in-loop filter 225. In the video encoding system 210 or the video decoding system 220, the NN in-loop filter is applied to the outputs of the loop filters (ALF, DF, SAO) to generate the final restored frame to be stored in a frame buffer (218 or 228) for display, transmission, or predictive coding of subsequent frames or pictures. Video encoding and decoding systems will be further described in Sections II and III below. (A frame buffer may be referred to as a decoded picture buffer in a decoding system or a reconstructed picture buffer in an encoding system.)

A convolution neural network (CNN) is a class of artificial neural network. A CNN uses mathematical convolution in place of general matrix multiplication in at least of its layers. CNNs can be specifically designed to process pixel data and are used in image recognition and processing. For a CNN in a video coding system (e.g., neural network in-loop filters 215 and 225), a feature map corresponds to a specific filter of the CNN and represents the response of that filter to an input image. Each element in the feature map represents the activation of a specific neuron in the network, and its value represents the degree to which the corresponding feature is present in the input image (e.g., feature detection). In some embodiments, for a CNN used in a video coding loop, a translation mechanism may be used to shift a feature map in a horizontal and/or vertical directions by certain offsets. The shift may be applied at the input or the intermediate activation of the CNN. The feature map translation mechanism can be used to compensate or correct for mismatches between the CNN's after-loop training and the CNN's in-loop operations.

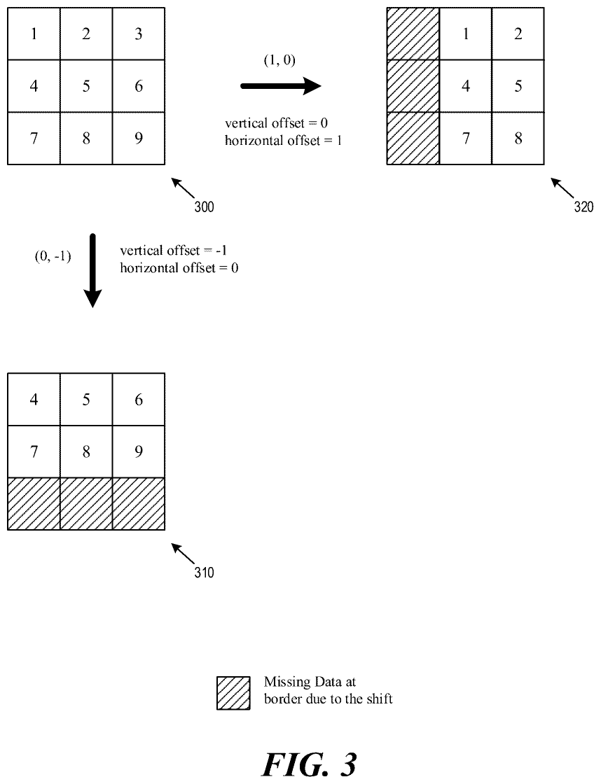

FIG. 3 conceptually illustrates shifting a feature map 300 in horizontal or vertical direction by certain offsets. The figure shows the feature map 300 shifted vertically by 1 (offset (0,−1)) to create a vertically shifted feature map 310. The figure also shows the feature map 300 shifted horizontally by 1 (offset (1,0)) to create a horizontally shifted feature map 320. The figure also illustrates missing data at the borders (shown in hash). The missing data can be accounted for by padding strategies such as filling the missing data with zeros, repeating the existing data, or mirroring the existing data, etc.

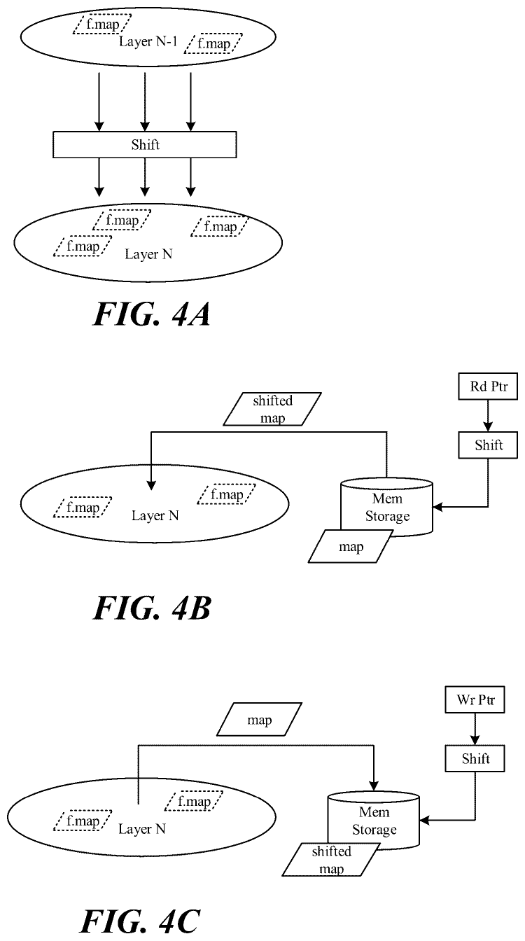

FIGS. 4A-C conceptually illustrates implementations of feature map shifting in different embodiments. In some embodiments, the shifting occurs explicitly by an independent operation that is executed between two layers of the CNN or before the first layer of the CNN. Specifically, by taking the output of the previous layer (if not before the first layer), shifting each feature map by an individual offset along the two spatial axes, and storing the result to be used as the input of the second layer. FIG. 4A shows feature map translation occurring by executing an independent operation between two lays of the CNN.

In some embodiments, the shifting occurs when a layer reads the input information. A single feature map is stored contiguously in a memory storage. The data is read from memory where the pointers that point to each feature map are offset according to the shifting. The data is then read into an operation buffer on which further arithmetic operations are carried out. FIG. 4B shows feature map translation occurring when data of a feature map is read from memory.

In some embodiments, the shifting occurs when a layer writes the input information. A single feature map is stored contiguously in memory. After the arithmetic operation of the layer has finished, the results are written back to memory. To account for the shifts of the feature maps, the pointers to each feature map are offset according to their specific shift. The feature map is then written according to the offset pointer. FIG. 4C shows feature map translation occurring when data of a feature map is written into memory.

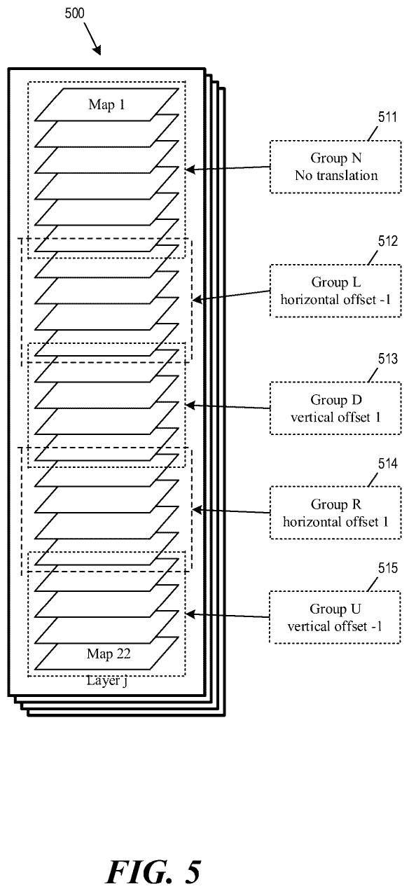

In some embodiments, different feature maps can be shifted by different offsets in either direction. In some embodiments, the feature maps are grouped into different translation groups, and the feature maps belonging to one translation group share the same shift command to apply the same shift offset. FIG. 5 conceptually illustrates a CNN layer having multiple different feature maps being shifted by different offsets in either direction. As illustrated, a particular layer (layer j) of a CNN 500 supports 22 feature maps. Translation commands 511-515 specifies the shifting offsets for the 22 different feature maps in five translation groups.

Feature maps of translation group ‘N’ (command 511) have no translation offset and does not shift. Feature maps of translation group ‘L’ (command 512) have horizontal offset of −1 to shift left by 1. Feature maps of translation group ‘D’ (command 513) have vertical offset of 1 to shift down by 1. Feature maps of translation group ‘R’ (command 514) have a horizontal offset of 1 to shift right by 1. Feature maps of translation group ‘U’ (command 515) have vertical offset of −1 to shift up by 1. In the example of FIG. 5, the translation group ‘N’ includes the feature maps 1-6, the translation group ‘L’ includes the feature maps 7-10, the translation group ‘D’ includes the feature maps 11-14, the translation group ‘R’ includes the feature maps 15-18, and the translation group ‘U’ includes the feature maps 19-22. The translation commands 511-515 are provided to the individual feature maps through communications channels, and the feature maps of translation groups ‘L’, ‘D’, ‘R’, ‘U’ are moved accordingly, with border padding applied.

In some embodiments, the shifts are well-defined (e.g., translation patterns, order of translation patterns, number of channels are already pre-determined for encoder and decoder) for all channels among different layers in the network structure. In some embodiments, the shifts can be signaled to the decoder. Table 1 below lists the flags used to inform the decoder of the feature map translation. Table 2 below shows example feature map translation configuration.

TABLE 1
Flags to Signal Feature map Translation Configuration

| Flag | Data type | Note |
|---|---|---|
| 1 | Boolean | For each layer: is feature map |
| | | translation active or not; |
| 2 | Integer | For each layer if flag 1 is true: Which |
| | | of the translation patterns is |
| | | used (see Table 2 for examples) |
| 3 | Boolean | For each layer if flag 1 is true: |
| | | Whether the number of channels for |
| | | each translation group is specified with |
| | | flag 4 or a default division is used. |
| 4 | Integer | For each layer if flag 3 |
| | | is true, for each translation |
| | | group according to flag 2 |
| | | (see Table 2 for examples) |
| 5 | Boolean | For each layer if flag 1 is true: |
| | | Whether the translation configurations |
| | | should be shifted by the amount |
| | | specified in syntax 6 |
| 6 | Integer | For each layer if flag 5 is true: |
| | (<number of | Offset to shift the order of the |
| | translation | translation configurations by |
| | configurations) | |

TABLE 2
Feature Map Translation Configurations/Patterns

| config | (0, 0) | (−1, 0) | (−1, 1) | (0, 1) | (1, 1) | (1, 0) | (1, −1) | (0, −1) | (−1, −1) |
|---|---|---|---|---|---|---|---|---|---|
| 1 | ✓ | ✓ | | ✓ | | ✓ | | ✓ | |
| 2 | ✓ | | ✓ | | ✓ | | ✓ | | ✓ |
| 3 | ✓ | | | ✓ | | | | ✓ | |
| 4 | ✓ | ✓ | | | | ✓ | | | |
| 5 | ✓ | | | | ✓ | | | | ✓ |
| 6 | ✓ | | ✓ | | | | ✓ | | |
| 7 | ✓ | ✓ | | | | | | ✓ | |
| 8 | ✓ | | | | | ✓ | | ✓ | |
| 9 | ✓ | ✓ | | ✓ | | | | | |
| 10 | ✓ | | | ✓ | | ✓ | | | |

Further explanations of the feature map related signals in Table 1 are as followed:
Flag 1: For each layer 1, a binary flag aₗ∈{0,1} indicates whether the feature map translation is active or not.
Flag 2: For each layer for which aₗ is true, an integer tₗ∈{0, . . . , T−1} follows, specifying which translation pattern or configuration is used (Table 2 provide an example set of translation patterns, with the number of possible translation patterns T being 10. In the example of FIG. 5, layer j, tₗ=1 to select config 1.)
Flag 3: For each layer that uses feature map translations, a binary flag cₗ∈{0,1} is signaled to indicate whether the number of channels (or feature maps) that are translated (e.g., being applied a shifting offset) according to one of the translation patterns is specified by flag 4 (if cₗ=1) or a default is used (if cₗ=0).
Flag 4: For each layer for which aₗ=1: if cₗ=1, then for each translation pattern p∈P (P is set of all possible translation patterns, e.g., Table 2) as specified by tₗ (except the last): a flag n_{l,p} indicates the number of channels or feature maps that the p-th translation of tₗ is applied to. The number of channels for the last pattern can then be inferred as the number of total channels must be known. In the example of FIG. 5, with tₗ=1 (the first configuration of Table 2)
   pattern 0 (0, 0); n_{l,0}=6 (group N),
   pattern 1 (−1, 0); n_{l,1}=4 (group L),
   pattern 2 (0, 1); n_{l,2}=4 (group D),
   pattern 3 (1, 0); n_{l,3}=4 (group R),
   pattern 4 (0, −1); n_{l,4}=4 (group U).
Flag 5: For each layer for which aₗ=1: flag sₗ∈{0,1} indicates whether the order of the translation configurations should be shifted by the amount specified in flag 6.
Flag 6: For each layer for which aₗ∧sₗ: the offset oₗ∈{1, #P−1} by which the order of the translation patterns is shifted. For oₗ=1 for example, the first pattern becomes the second, the second becomes the third, and so forth, until the last becomes the first. Note that #P indicates the number of patterns in the translation configuration, e.g., five for the first configuration listed in Table 2.

In some embodiments, a syntax signaling mechanism is provided according to the following:
1. For each layer 1, a binary flag aₗ∈{0,1} indicates whether the feature map translation is active or not.
2. For each layer for which aₗ is true, an integer tₗ∈{0, . . . . T−1} follows, specifying which translation pattern is used (e.g., Table 2). Note that the number of patterns, T, can differ from that listed in Table 2. (T=10 in the example of Table 2)
3. For each layer for which aₗ=1: for a translation pattern p∈P as specified by tₗ (except the last): the flag n_{l,p} indicates the number of channels that the p-th translation of tₗ is applied to. The number of channels for the last pattern can then be inferred as the number of total channels must be known.

In some embodiments, the number of channels that each translation applied to are assumed to be the same, except for the first translation pattern (0,0). Thus, only the number of channels applied with (0,0) translation pattern is specified:
1. For each layer 1, a binary flag aₗ∈{0,1} indicates whether the feature map translation is active or not.
2. For each layer for which aₗ is true, an integer tₗ∈{0, . . . , T−1} follows, specifying which translation pattern is used (see Table 2 for examples). Note that the number of patterns, T, can differ from that listed in Table 2.
3. For each layer for which aₗ=1: for each translation pattern p∈P as specified by tₗ (except the last): the flag n_{l,0} indicates the number of channels that the (0,0) translation pattern is applied to. The number of channels for the other patterns can then be inferred as (total channels−n_{l,0})/(#P−1). (#P indicates the number of patterns in the translation configuration.)

In some embodiments, the number of channels that each translation applied to is assumed to be the same. Thus, the number of channels that each translation pattern applied to is infer to be (total channels)/#P (#P indicates the number of patterns in the translation configuration:
1. For each layer l, a binary flag aₗ∈{0,1} indicates whether the feature map translation is active or not.
2. For each layer for which aₗ is true, an integer tₗ∈{0, . . . , T−1} follows, specifying which translation pattern is used (see Table 2 for examples). Note that the number of patterns, T, can differ from that listed in Table 2.

In some embodiments, a flexible order of the translation is used. Instead of using an offset oₗ∈{1, #P−1} to shift the order of translation patterns, the specific order of translation patterns can be allowed when the index i_{l,p} is introduced. Table 3 lists the flags used to inform the decoder of the feature map translation.

TABLE 3
Flags to signal feature map translation configuration
with flexible order of translation patterns:

| Flag ID | Data type | Note |
|---|---|---|
| 1 | Boolean | For each layer: is feature |
| | | map translation active or not |
| 2 | Integer | For each layer if flag 1 is true: |
| | | Which of the translation patterns |
| | | is used (see Table 2 for examples) |
| 3 | Boolean | For each layer if flag 1 is true: |
| | | Whether the number of channels |
| | | for each translation |
| | | group is specified with flag 4 |
| | | or a default division is used. |
| 4 | Integer | For each layer if flag 3 is true, |
| | | for each translation group according |
| | | to flag 2 (see Table 2 for examples) |
| 5 | Boolean | For each layer if flag 1 is true: |
| | | Whether the translation |
| | | configurations should be shifted by |
| | | the amount specified in flag 6 |
| 6 | Integer (<number of | For each layer if flag 5 is true: |
| | translation | Index to reorder the |
| | configurations) | translation patterns |

Further explanation of the syntax signaling mechanism in Table 3 is provided below:
Flag 1: For each layer 1, a binary flag aₗ∈{0,1} indicates whether the feature map translation is active or not.
Flag 2: For each layer for which aₗ is true, an integer tₗ∈{0, . . . , T−1} follows, specifying which translation pattern is used (see Table 2 for examples). Note that the number of patterns, T, can differ from that listed in Table 2.
Flag 3: For each layer that uses feature map translations, a binary flag cₗ∈{0,1} is signaled indicating whether the number of channels that are translated according to one of the translational patterns is specified in the following (if cₗ=1) or a default is used (if cₗ=0).
Flag 4: For each layer for which aₗ=1: if cₗ=1, then for each translation pattern p∈P as specified by tₗ (except the last): the flag n_{l,p} indicates the number of channels that the p-th translation of tₗ is applied to. The number of channels for the last pattern can then be inferred as the number of total channels must be known.
Flag 5: For each layer for which aₗ=1: flag sₗ∈{0,1} indicates whether the order of the translation configurations should be changed. If sₗ=0, the default order of the translation patterns is adopted. For example, the first pattern is (0,0), the second pattern is (−1,0), the third pattern is (0,1), the forth pattern is (1,0) and the final pattern is (0,−1) in the first configuration listed in Table 2. If sₗ=1, the index i_{l,p} are further specified in the following.
Flag 6: For each layer for which aₗ∧sₗ: the index i_{l,p}∈{0, #P−1} indicates the order of the translation patterns. For example, i_{l,0}=1 means that the first pattern becomes the second pattern. For another example, i_{l,1}=3 means that the second pattern becomes the fourth pattern.

In some embodiments, the shifts are predefined for channels in partial layers in the network structure (e.g., predefined in the decoder or implicitly determined at the decoder). The above flags are used only for the layers that are not predefined layers, and the number of flags can be further reduced. These flags are signaled whenever a set of full or partial neural network parameters is signaled to the decoder. With the signaled information, the decoder assembles the CNN's functionality. The CNN is then be applied to the restored image where the parameter set is chosen according to which pixel(s) are being reconstructed.

The description in the above is an example. It is not necessary to apply all parts in the above method together. For example, in some embodiments, flags 3 and 4 are not available and a default assignment of the number of channels to each translation pattern is used. In some embodiments, flags 5 and 6 are not used and a default shift of 1 is applied to all layers using feature map translation.

### II. Example Video Encoder

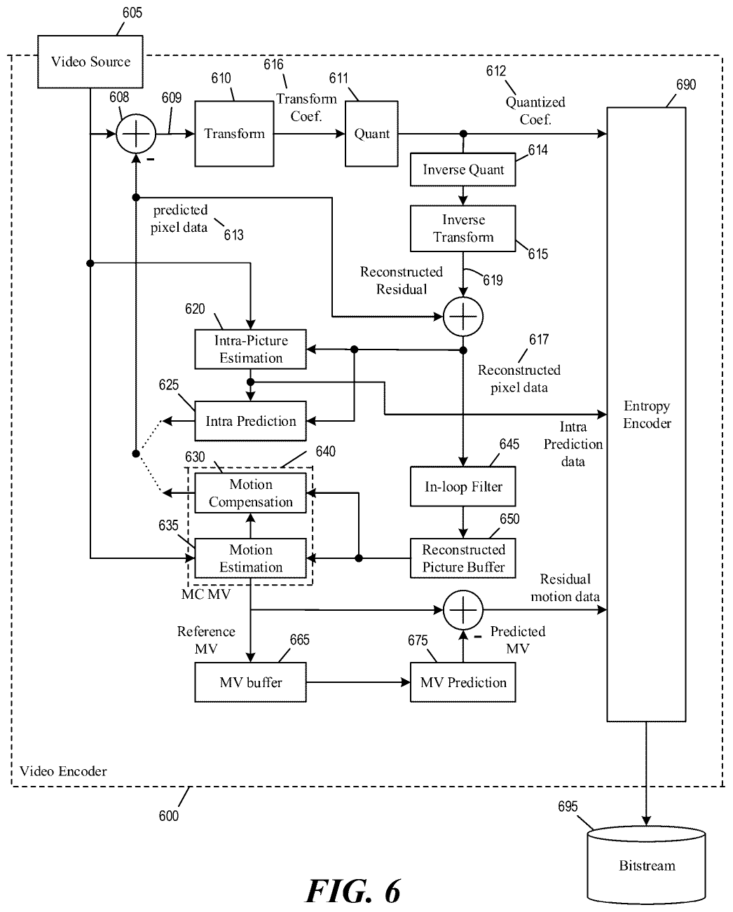

FIG. 6 illustrates an example video encoder 600 that may implement an in-loop neural network filter. As illustrated, the video encoder 600 receives input video signal from a video source 605 and encodes the signal into bitstream 695. The video encoder 600 has several components or modules for encoding the signal from the video source 605, at least including some components selected from a transform module 610, a quantization module 611, an inverse quantization module 614, an inverse transform module 615, an intra-picture estimation module 620, an intra-prediction module 625, a motion compensation module 630, a motion estimation module 635, an in-loop filter 645, a reconstructed picture buffer 650, a MV buffer 665, and a MV prediction module 675, and an entropy encoder 690. The motion compensation module 630 and the motion estimation module 635 are part of an inter-prediction module 640.

In some embodiments, the modules 610-690 are modules of software instructions being executed by one or more processing units (e.g., a processor) of a computing device or electronic apparatus. In some embodiments, the modules 610-690 are modules of hardware circuits implemented by one or more integrated circuits (ICs) of an electronic apparatus. Though the modules 610-690 are illustrated as being separate modules, some of the modules can be combined into a single module.

The video source 605 provides a raw video signal that presents pixel data of each video frame without compression. A subtractor 608 computes the difference between the raw video pixel data of the video source 605 and the predicted pixel data 613 from the motion compensation module 630 or intra-prediction module 625 as prediction residual 609. The transform module 610 converts the difference (or the residual pixel data or residual signal 608) into transform coefficients (e.g., by performing Discrete Cosine Transform, or DCT). The quantization module 611 quantizes the transform coefficients into quantized data (or quantized coefficients) 612, which is encoded into the bitstream 695 by the entropy encoder 690.

The inverse quantization module 614 de-quantizes the quantized data (or quantized coefficients) 612 to obtain transform coefficients, and the inverse transform module 615 performs inverse transform on the transform coefficients to produce reconstructed residual 619. The reconstructed residual 619 is added with the predicted pixel data 613 to produce reconstructed pixel data 617. In some embodiments, the reconstructed pixel data 617 is temporarily stored in a line buffer (not illustrated) for intra-picture prediction and spatial MV prediction. The reconstructed pixels are filtered by the in-loop filter 645 and stored in the reconstructed picture buffer 650. In some embodiments, the reconstructed picture buffer 650 is a storage external to the video encoder 600. In some embodiments, the reconstructed picture buffer 650 is a storage internal to the video encoder 600.

The intra-picture estimation module 620 performs intra-prediction based on the reconstructed pixel data 617 to produce intra prediction data. The intra-prediction data is provided to the entropy encoder 690 to be encoded into bitstream 695. The intra-prediction data is also used by the intra-prediction module 625 to produce the predicted pixel data 613.

The motion estimation module 635 performs inter-prediction by producing MVs to reference pixel data of previously decoded frames stored in the reconstructed picture buffer 650. These MVs are provided to the motion compensation module 630 to produce predicted pixel data.

Instead of encoding the complete actual MVs in the bitstream, the video encoder 600 uses MV prediction to generate predicted MVs, and the difference between the MVs used for motion compensation and the predicted MVs is encoded as residual motion data and stored in the bitstream 695.

The MV prediction module 675 generates the predicted MVs based on reference MVs that were generated for encoding previously video frames, i.e., the motion compensation MVs that were used to perform motion compensation. The MV prediction module 675 retrieves reference MVs from previous video frames from the MV buffer 665. The video encoder 600 stores the MVs generated for the current video frame in the MV buffer 665 as reference MVs for generating predicted MVs.

The MV prediction module 675 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 695 by the entropy encoder 690.

The entropy encoder 690 encodes various parameters and data into the bitstream 695 by using entropy-coding techniques such as context-adaptive binary arithmetic coding (CABAC) or Huffman encoding. The entropy encoder 690 encodes various header elements, flags, along with the quantized transform coefficients 612, and the residual motion data as syntax elements into the bitstream 695. The bitstream 695 is in turn stored in a storage device or transmitted to a decoder over a communications medium such as a network.

The in-loop filter 645 performs filtering or smoothing operations on the reconstructed pixel data 617 to reduce the artifacts of coding, particularly at boundaries of pixel blocks. In some embodiments, the filtering or smoothing operations performed by the in-loop filter 645 include deblock filter (DBF), sample adaptive offset (SAO), and/or adaptive loop filter (ALF).

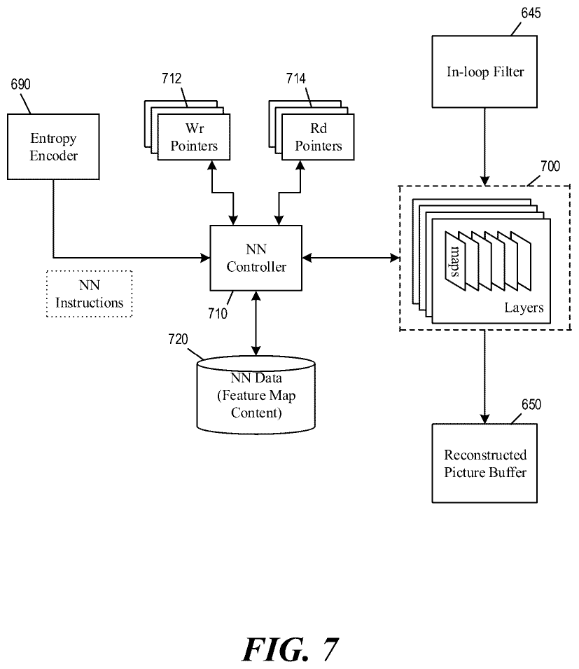

FIG. 7 illustrates portions of the video encoder 600 that implement an in-loop neural network filter 700. Specifically, the figure illustrates the components of the encoder 600 that facilitate shifting of feature maps in layers of the neural network filter 700. The neural network filter 700 is an in-loop filter as it receives filtered samples produced by other in-loop filters 645 (including SAO, DF, ALF) and generates further filtered samples to be stored in the reconstructed picture buffer 650.

The neural network filter 700 is a CNN that includes processing elements for multiple layers of neurons, each layer supporting one or more feature maps. A NN data storage 720 stores the parameters (e.g., connection weights) of the neural network, including content of the various feature maps in different layers.

A neural network (NN) controller 710 controls the parameters of the neural network 700, including the updating or modification of feature maps. The NN controller 710 maintains write pointers 712 and read pointers 714 for the various feature maps in the layers of the neural network filter 700. The controller 710 may receive instructions for shifting specific group(s) of feature maps in specific layer(s) of the neural network filter 700 from the entropy encoder 690 and implement the shift accordingly. The controller 710 may implement the shift by applying offsets to read pointers or write pointers while retrieving or storing data of the feature maps. The controller 710 may also directly manipulate content of the NN data storage 720 to implement the shift for specific feature maps. The instructions for shifting feature maps are described above by reference to Tables 1-3 above.

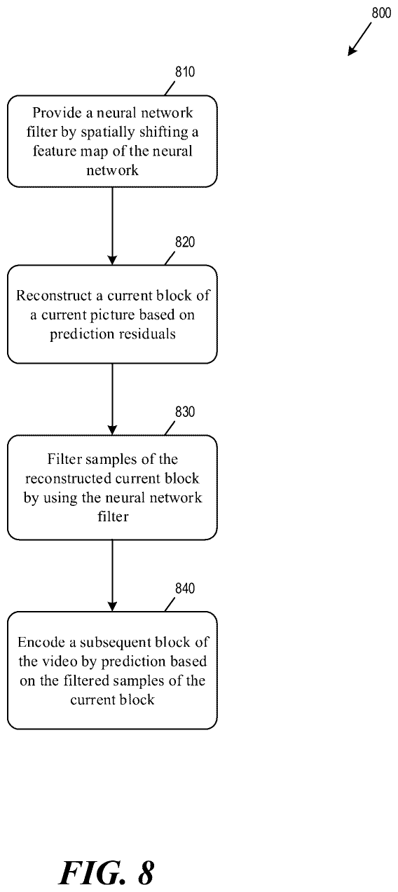

FIG. 8 conceptually illustrates a process 800 for encoding video pictures using an in-loop neural network filter. In some embodiments, one or more processing units (e.g., a processor) of a computing device implementing the encoder 600 performs the process 800 by executing instructions stored in a computer readable medium. In some embodiments, an electronic apparatus implementing the encoder 600 performs the process 800.

The encoder provides (at block 810) a neural network filter by spatially (e.g., vertically or horizontally) shifting a feature map of the neural network. The neural network has a plurality of layers, each layer supporting one or more feature maps. In some embodiments, the neural network filter is trained by data that is generated outside of a video coding loop.

In some embodiments, the encoder provides the neural network by identifying one or more layers having feature maps to be shifted. The encoder may identify a set of different translation offsets to be applied to feature maps of the identified layer, with each translation offset specifying a pattern of movement for shifting a feature map. In some embodiments, each translation offset in the set of translation offsets is applicable to a group of one or more feature maps of the identified layer. In some embodiments, the encoder signals a specification of translation offsets of feature maps for only a subset of the plurality of layers and not all layers of the neural network.

In some embodiments, the encoder shifts the feature map by filling vacated elements of the feature map with padding samples. In some embodiments, the encoder shifts the feature map by shifting an output of the feature map in a first layer of the neural network according to an offset and applying the shifted output as input to a second layer of the neural network. In some embodiments, the encoder shifts the feature map by applying an offset to a read pointer that is used to retrieve data of the feature map from a storage. In some embodiments, the encoder shifts the feature map by applying an offset to a write pointer that is used to store data of the feature map to a storage.

The encoder reconstructs (at block 820) a current block of pixels of a current picture of a video based on prediction residuals generated by the encoder. The encoder filters (at block 830) samples of the reconstructed current block by using the neural network filter. The filter samples may be stored in the reconstructed picture buffer (or frame buffer). The encoder encodes (at block 840) a subsequent block of the video by inter- or intra-prediction based on the filtered samples of the current block that is stored in the reconstructed picture buffer.

### III. Example Video Decoder

In some embodiments, an encoder may signal (or generate) one or more syntax element in a bitstream, such that a decoder may parse said one or more syntax element from the bitstream.

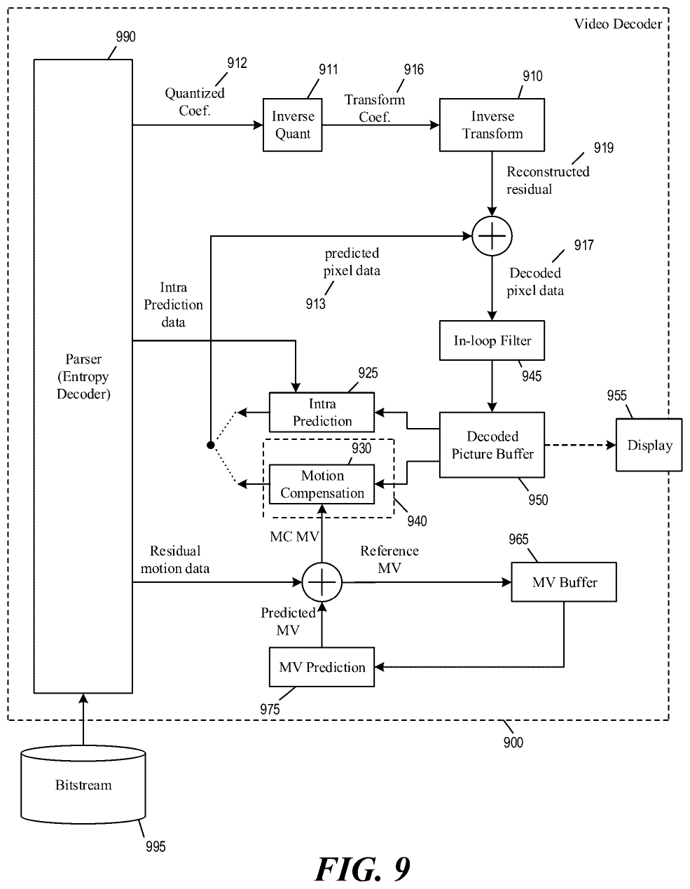

FIG. 9 illustrates an example video decoder 900 that may implement an in-loop neural network filter. As illustrated, the video decoder 900 is an image-decoding or video-decoding circuit that receives a bitstream 995 and decodes the content of the bitstream into pixel data of video frames for display. The video decoder 900 has several components or modules for decoding the bitstream 995, including some components selected from an inverse quantization module 911, an inverse transform module 910, an intra-prediction module 925, a motion compensation module 930, an in-loop filter 945, a decoded picture buffer 950, a MV buffer 965, a MV prediction module 975, and a parser 990. The motion compensation module 930 is part of an inter-prediction module 940.

In some embodiments, the modules 910-990 are modules of software instructions being executed by one or more processing units (e.g., a processor) of a computing device. In some embodiments, the modules 910-990 are modules of hardware circuits implemented by one or more ICs of an electronic apparatus. Though the modules 910-990 are illustrated as being separate modules, some of the modules can be combined into a single module.

The parser 990 (or entropy decoder) receives the bitstream 995 and performs initial parsing according to the syntax defined by a video-coding or image-coding standard. The parsed syntax element includes various header elements, flags, as well as quantized data (or quantized coefficients) 912. The parser 990 parses out the various syntax elements by using entropy-coding techniques such as context-adaptive binary arithmetic coding (CABAC) or Huffman encoding.

The inverse quantization module 911 de-quantizes the quantized data (or quantized coefficients) 912 to obtain transform coefficients, and the inverse transform module 910 performs inverse transform on the transform coefficients 916 to produce reconstructed residual signal 919. The reconstructed residual signal 919 is added with predicted pixel data 913 from the intra-prediction module 925 or the motion compensation module 930 to produce decoded pixel data 917. The decoded pixels data are filtered by the in-loop filter 945 and stored in the decoded picture buffer 950. In some embodiments, the decoded picture buffer 950 is a storage external to the video decoder 900. In some embodiments, the decoded picture buffer 950 is a storage internal to the video decoder 900.

The intra-prediction module 925 receives intra-prediction data from bitstream 995 and according to which, produces the predicted pixel data 913 from the decoded pixel data 917 stored in the decoded picture buffer 950. In some embodiments, the decoded pixel data 917 is also stored in a line buffer (not illustrated) for intra-picture prediction and spatial MV prediction.

In some embodiments, the content of the decoded picture buffer 950 is used for display. A display device 955 either retrieves the content of the decoded picture buffer 950 for display directly, or retrieves the content of the decoded picture buffer to a display buffer. In some embodiments, the display device receives pixel values from the decoded picture buffer 950 through a pixel transport.

The motion compensation module 930 produces predicted pixel data 913 from the decoded pixel data 917 stored in the decoded picture buffer 950 according to motion compensation MVs (MC MVs). These motion compensation MVs are decoded by adding the residual motion data received from the bitstream 995 with predicted MVs received from the MV prediction module 975.

The MV prediction module 975 generates the predicted MVs based on reference MVs that were generated for decoding previous video frames, e.g., the motion compensation MVs that were used to perform motion compensation. The MV prediction module 975 retrieves the reference MVs of previous video frames from the MV buffer 965. The video decoder 900 stores the motion compensation MVs generated for decoding the current video frame in the MV buffer 965 as reference MVs for producing predicted MVs.

The in-loop filter 945 performs filtering or smoothing operations on the decoded pixel data 917 to reduce the artifacts of coding, particularly at boundaries of pixel blocks. In some embodiments, the filtering or smoothing operations performed by the in-loop filter 945 include deblock filter (DBF), sample adaptive offset (SAO), and/or adaptive loop filter (ALF).

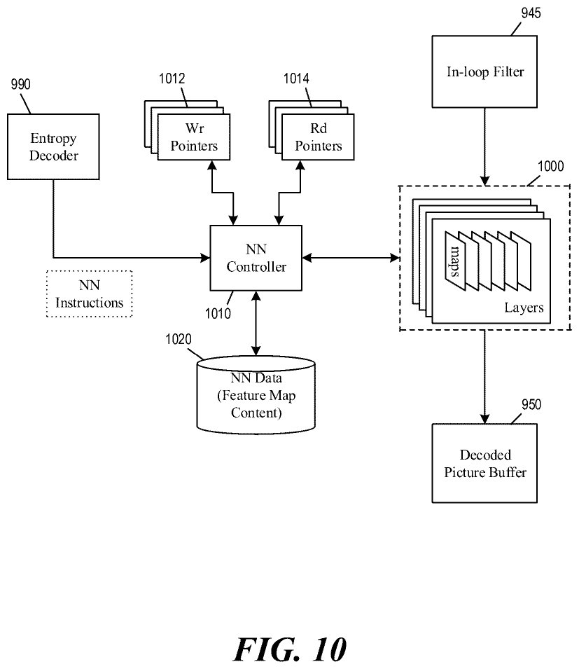

FIG. 10 illustrates portions of the video decoder 900 that implement an in-loop neural network filter 1000. Specifically, the figure illustrates the components of the decoder 900 that facilitate shifting of feature maps in layers of the neural network filter 1000. The neural network filter 1000 is an in-loop filter as it receives filtered samples produced by other in-loop filters 945 (including SAO, DF, ALF) and generates further filtered samples to be stored in the decoded picture buffer 950.

The neural network filter 1000 is a CNN that includes processing elements for multiple layers of neurons, each layer supporting one or more feature maps. A NN data storage 1020 stores the parameters (e.g., connection weights) of the neural network, including content of the various feature maps in different layers.

A neural network (NN) controller 1010 controls the parameters of the neural network 1000, including the updating or modification of feature maps. The NN controller 1010 maintains write pointers 1012 and read pointers 1014 for the various feature maps in the layers of the neural network filter 1000. The controller 1010 may receive instructions for shifting specific group(s) of feature maps in specific layer(s) of the neural network filter 1010 from the entropy decoder 990 and implement the shift accordingly. The controller 1010 may implement the shift by applying offsets to read pointers or write pointers while retrieving or storing data of the feature maps. The controller 1010 may also directly manipulate content of the NN data storage 1020 to implement the shift for specific feature maps. The instructions for shifting feature maps are described above by reference to Tables 1-3 above.

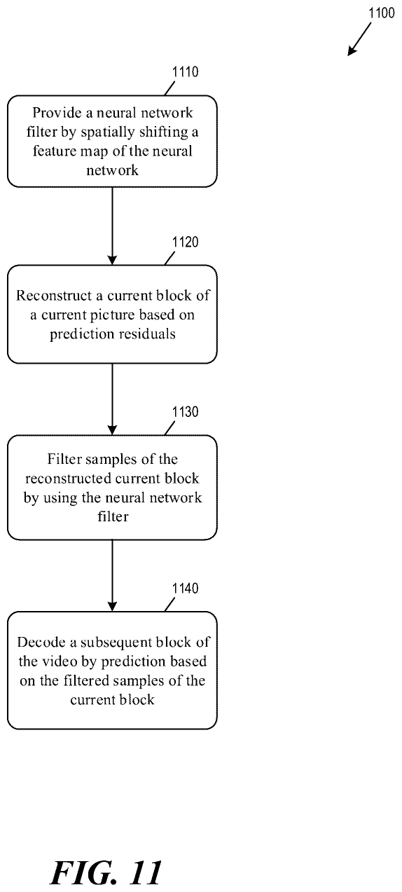

FIG. 11 conceptually illustrates a process 1100 for decoding video pictures using an in-loop neural network filter. In some embodiments, one or more processing units (e.g., a processor) of a computing device implementing the decoder 900 performs the process 1100 by executing instructions stored in a computer readable medium. In some embodiments, an electronic apparatus implementing the decoder 900 performs the process 1100.

The decoder provides (at block 1110) a neural network filter by spatially (e.g., vertically or horizontally) shifting a feature map of the neural network. The neural network has a plurality of layers, each layer supporting one or more feature maps. In some embodiments, the neural network filter is trained by data that is generated outside of a video coding loop.

In some embodiments, the decoder provides the neural network by identifying one or more layers having feature maps to be shifted. The decoder may identify a set of different translation offsets to be applied to feature maps of the identified layer, with each translation offset specifying a pattern of movement for shifting a feature map. In some embodiments, each translation offset in the set of translation offsets is applicable to a group of one or more feature maps of the identified layer. In some embodiments, the decoder receives a specification of translation offsets of feature maps for only a subset of the plurality of layers and not all layers of the neural network. The signaling of translation offsets of feature maps is described by reference to Tables 1-3 above.

In some embodiments, the decoder shifts the feature map by filling vacated elements of the feature map with padding samples. In some embodiments, the decoder shifts the feature map by shifting an output of the feature map in a first layer of the neural network according to an offset and applying the shifted output as input to a second layer of the neural network. In some embodiments, the decoder shifts the feature map by applying an offset to a read pointer that is used to retrieve data of the feature map from a storage. In some embodiments, the decoder shifts the feature map by applying an offset to a write pointer that is used to store data of the feature map to a storage.

The decoder reconstructs (at block 1120) a current block of pixels of a current picture of a video based on prediction residuals received by the decoder. The decoder filters (at block 1130) samples of the reconstructed current block by using the neural network filter. The filter samples may be stored in the decoded picture buffer (or frame buffer). The decoder decodes (at block 1140) a subsequent block of the video by inter- or intra-prediction based on the filtered samples of the current block that is stored in the decoded picture buffer.

### IV. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

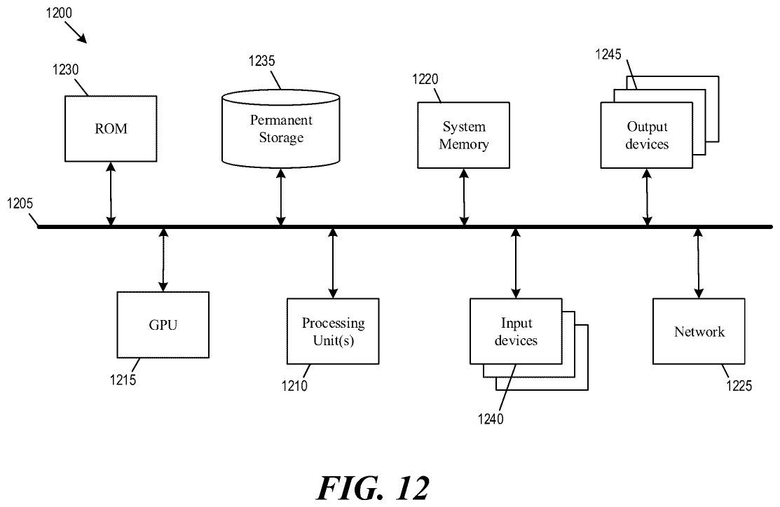

FIG. 12 conceptually illustrates an electronic system 1200 with which some embodiments of the present disclosure are implemented. The electronic system 1200 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 1200 includes a bus 1205, processing unit(s) 1210, a graphics-processing unit (GPU) 1215, a system memory 1220, a network 1225, a read-only memory 1230, a permanent storage device 1235, input devices 1240, and output devices 1245.

The bus 1205 collectively represents all system, peripheral, and chipset buses that communicatively connect the numerous internal devices of the electronic system 1200. For instance, the bus 1205 communicatively connects the processing unit(s) 1210 with the GPU 1215, the read-only memory 1230, the system memory 1220, and the permanent storage device 1235.

From these various memory units, the processing unit(s) 1210 retrieves instructions to execute and data to process in order to execute the processes of the present disclosure. The processing unit(s) may be a single processor or a multi-core processor in different embodiments. Some instructions are passed to and executed by the GPU 1215. The GPU 1215 can offload various computations or complement the image processing provided by the processing unit(s) 1210.

The read-only-memory (ROM) 1230 stores static data and instructions that are used by the processing unit(s) 1210 and other modules of the electronic system. The permanent storage device 1235, on the other hand, is a read-and-write memory device. This device is a non-volatile memory unit that stores instructions and data even when the electronic system 1200 is off. Some embodiments of the present disclosure use a mass-storage device (such as a magnetic or optical disk and its corresponding disk drive) as the permanent storage device 1235.

Other embodiments use a removable storage device (such as a floppy disk, flash memory device, etc., and its corresponding disk drive) as the permanent storage device. Like the permanent storage device 1235, the system memory 1220 is a read-and-write memory device. However, unlike storage device 1235, the system memory 1220 is a volatile read-and-write memory, such a random access memory. The system memory 1220 stores some of the instructions and data that the processor uses at runtime. In some embodiments, processes in accordance with the present disclosure are stored in the system memory 1220, the permanent storage device 1235, and/or the read-only memory 1230. For example, the various memory units include instructions for processing multimedia clips in accordance with some embodiments. From these various memory units, the processing unit(s) 1210 retrieves instructions to execute and data to process in order to execute the processes of some embodiments.

The bus 1205 also connects to the input and output devices 1240 and 1245. The input devices 1240 enable the user to communicate information and select commands to the electronic system. The input devices 1240 include alphanumeric keyboards and pointing devices (also called “cursor control devices”), cameras (e.g., webcams), microphones or similar devices for receiving voice commands, etc. The output devices 1245 display images generated by the electronic system or otherwise output data. The output devices 1245 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 12, bus 1205 also couples electronic system 1200 to a network 1225 through a network adapter (not shown). In this manner, the computer can be a part of a network of computers (such as a local area network (“LAN”), a wide area network (“WAN”), or an Intranet, or a network of networks, such as the Internet. Any or all components of electronic system 1200 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 8 and FIG. 11) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video coding method comprising:
providing a neural network filter by spatially shifting a feature map of the neural network;
reconstructing a current block of pixels of a current picture of a video based on prediction residuals;
filtering samples of the reconstructed current block by using the neural network filter; and
encoding or decoding a subsequent block of the video by prediction based on the filtered samples of the current block.

2. The video coding method of claim 1, wherein the neural network filter is trained by data that is generated outside of a video coding loop.

3. The video coding method of claim 1, wherein shifting the feature map comprises filling vacated elements of the feature map with padding samples.

4. The video coding method of claim 1, wherein shifting the feature map comprises shifting an output of the feature map in a first layer of the neural network according to an offset and applying the shifted output as input to a second layer of the neural network.

5. The video coding method of claim 1, wherein shifting the feature map comprises applying an offset to a read pointer that is used to retrieve data of the feature map from a storage.

6. The video coding method of claim 1, wherein shifting the feature map comprises applying an offset to a write pointer that is used to store data of the feature map to a storage.

7. The video coding method of claim 1, wherein the neural network comprises a plurality of layers, each layer supporting one or more feature maps.

8. The video coding method of claim 7, wherein providing the neural network comprises identifying one or more layers having feature maps to be shifted.

9. The video coding method of claim 8, wherein providing the neural network further comprises identifying a set of different translation offsets to be applied to feature maps of an identified layer, each translation offset specifying a pattern of movement for shifting a feature map.

10. The video coding method of claim 9, wherein each translation offset in the set of translation offsets is applicable to a group of one or more feature maps of the identified layer.

11. The video coding method of claim 7, wherein providing the neural network comprises receiving or signaling translation offsets of feature maps for only a subset of the plurality of layers and not all layers of the neural network.

12. An electronic apparatus comprising:
a video coder circuit configured to perform operations comprising:
providing a neural network filter by spatially shifting a feature map of the neural network;
reconstructing a current block of pixels of a current picture of a video based on prediction residuals;
filtering samples of the reconstructed current block by using the neural network filter; and
encoding or decoding a subsequent block of the video by prediction based on the filtered samples of the current block.

13. A video decoding method comprising:
providing a neural network filter by spatially shifting a feature map of the neural network;
reconstructing a current block of pixels of a current picture of a video based on prediction residuals received by a decoder;
filtering samples of the reconstructed current block by using the neural network filter; and
encoding or decoding a subsequent block of the video by prediction based on the filtered samples of the current block.
